(19) United States
(12) Patent Application Publication
(10) Pub. No.: US 2009/0133550 A1
(43) Pub. Date: May 28, 2009

(54) Illuminated Hunting Tag Punch

(76) Inventor: Gregory J. Meyer, Le Sueur, MN (US)

Correspondence Address: MERCHANT & GOULD PC, P.O. BOX 2903, MINNEAPOLIS, MN, 55402-0903, US

(21) Appl. No.: 12/277,803

(22) Filed: Nov. 25, 2008

Related U.S. Application Data
(60) Provisional application No. 60/990,491, filed on Nov. 27, 2007.

(51) Int. Cl. A01M 31/00; B26D 7/00; B26F 1/32

(52) U.S. Cl. 83/30; 83/520; 83/686

(57) ABSTRACT

An illuminated punch includes a punch, a light source, and a body. The punch includes a facet. The body is configured to receive a tag, receive the punch, and receive the light source such that the light source may be activated to illuminate an area proximate the facet. The punch is then used to mark the hunting tag.

### RELATED APPLICATION

This application claims priority to U.S. Provisional Application No. 60/990,491 filed on Nov. 27, 2007, entitled ILLUMINATED HUNTING TAG PUNCH, the disclosure of which is incorporated by reference herein in its entirety.

### TECHNICAL FIELD

The present disclosure relates to punch devices that can be used to mark hunting tags and can be illuminated for ease of use in low-light situations.

### BACKGROUND

Generally, under various state laws hunters are required to place a tag, also know as tagging, on game they have killed. The tag must be marked with the date and time when the animal was killed. Currently, when tagging game, the hunter marks the tag using a pocketknife or some other sharp instrument. Problems arise when the hunter is attempting to tag his game during twilight hours, nighttime hours, early morning, or other times when visibility is limited due to low lighting conditions. The use of a pocket knife or other sharp instrument in combination with low lighting conditions can easily lead the hunter to cut himself and/or destroy the tag being applied to game. In addition, trying to hold a light source such as a flashlight while tagging game can be difficult, because the hunter is trying to hold the tag, marking instrument, and light source at the same time.

### SUMMARY

Embodiments of the present disclosure comprise a punch having a facet, a light source, and a body. The body can be configured to receive the punch and the light source. The body can be further configured such that the light source can be activated and illuminate an area proximate the facet

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts a bottom view drawing of an example illuminated hunting tag punch body;

FIG. 2 depicts a side view drawing of an illuminated hunting tag punch body;

FIG. 3 depicts a top view drawing of an illuminated hunting tag punch body;

FIG. 4 depicts a side view drawing of an illuminated hunting tag punch body;

FIG. 5 depicts a cross-sectional view of the illuminated hunting tag punch body indicated in FIG. 3;

FIG. 6 depicts a punch for use with the illuminated hunting tag punch body shown in FIGS. 1-5;

FIG. 7 is an exploded assembly of an illuminated hunting tag punch; and

FIG. 8 is a cross-sectional view of another embodiment of the illuminated hunting tag punch in an assembled configuration.

### DETAILED DESCRIPTION

Various examples are described more fully below with reference to the accompanying drawings, which form a part hereof, and which show specific examples of the inventive concepts disclosed herein. However, embodiments can be implemented in many different forms and should not be construed as limited to the examples set forth herein; rather, these examples are provided so that this disclosure will be thorough and complete, and will fully convey the scope of the inventive concept disclosed herein to those skilled in the art. Accordingly, the following detailed description is, therefore, not to be taken in a limiting sense.

Tags are usually rectangular pieces of paper with days of the week, days of the month, and/or time of day printed around the edge or on its face. Usually, the tags are made from a heavy paper, such as a card stock, to limit inadvertent damage such as tearing or moisture damage. Properly marking the tag after a kill is very important. If the tag is not marked correctly, the hunter could face arrest, expensive fines, and/or risk confiscation of his gun, truck, killed game, hunting license, etc.

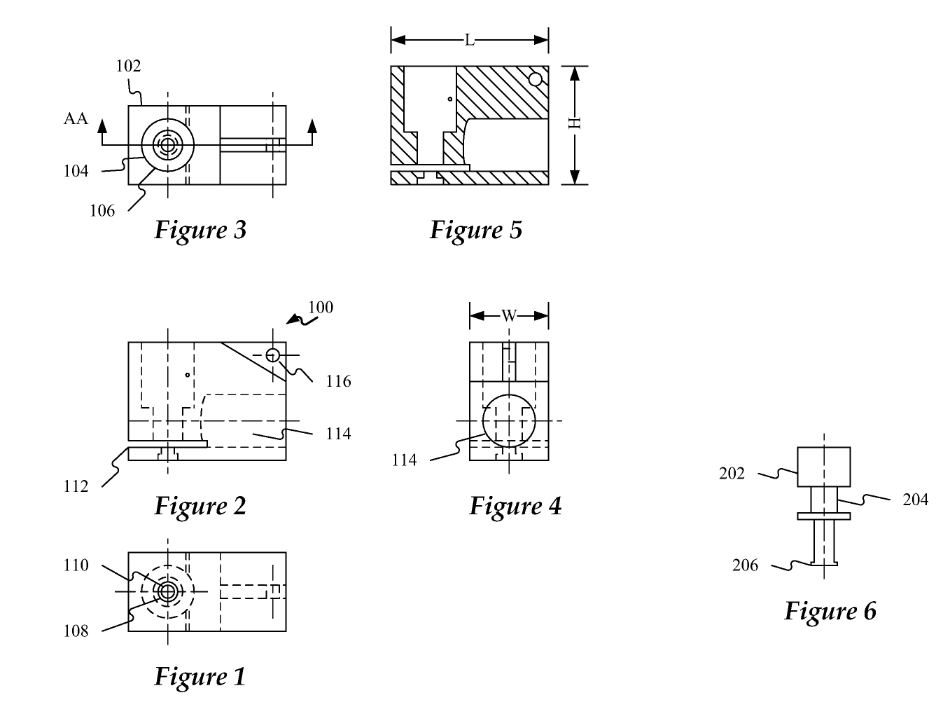

Referring now to the figures, FIGS. 1-5 depict multiple views of a body 102 of an example illuminated hunting tag punch 100. Body 102 can comprise holes 104, 106, 108, and 110. Hole 104 can be sized such that punch 202 (see FIG. 2) can protrude above the top of body 102 to allow a hunter cause punch 202 to puncture a tag during illuminated hunting tag punch operation.

Body 102 further includes opening 112. Opening 112 is sized to permit a tag to be placed within the illuminated hole punch for marking and/or punching. Depending on the application, opening 112 can be configured to mark the tag at an optimum location. Opening 112 can be sized for a particular tag size and shape. For example, tags for marking different animals may be different in shape and size. For instance, a tag for deer may have a different shape than a tag for elk. The illuminated hunting tag punch can be specifically designed for a particular tag. In addition, while not shown, opening 112 can include graduations to help the user measure for marking locations. Furthermore, opening 112 can be adjustable. For example, opening 112 may contain a slide or other mechanism configured to allow for the depth or angle that the tag can be inserted to be adjusted. Moreover, opening 112 can be tapered to allow easier tag insertion. For instance, opening 112's mouth can be larger than its base.

In addition, block 102 can further include hole 116. Hole 116 can be used to connect various items to block 102. By way of example and not limitation, the key ring can be used to attach items such as keys, lanyards, karabiners, hunting tags, light sources, etc. For example, a key ring (not shown) can be secured block 102 from which a lanyard and a light sources can be attached. In addition, the illuminated hole punch can be secured to a hunter via a karabiner attached to hole 116.

Block 102 further includes hole 114. Hole 114 can be a drilled hole that progresses from one facet of block 102 until a portion of hole 114 intersects opening 112. By having hole 114 intersect opening 112, luminescence created within the cavity formed by hole 114 can illuminate an area proximate the illuminated tag hole punch. While hole 114 is shown as a cylindrical style, hole it is contemplated that hole 114 can be tapered to accommodate, for example, a light source such as a flashlight (e.g. SOLITAIRE model flashlight by MAGLITE of Ontario Calif.). The tapered nature of hole 114 can allow for a compression fit to be formed upon inserting an object into hole 114. For example, have hole 114 tapered can allow for a flashlight to become “wedged” into hole 114 whereby the flashlight can be held in place via friction.

Other aspects of the invention can include tapping hole 114 such that a threaded member can be inserted into hole 114. For example, instead of wedging a flashlight into hole 114, the flashlight can contain a threaded portion and the flashlight can be screwed into hole 114. Still consistent with embodiments of the invention, electronics can be contained within hole 114. A threaded cap can be used to cover the electronics positioned within hole 114. For example, a light emitting diode (LED) and a power source can be contained within hole 114. A threaded cap can be used, for example, as a switch to active the LED. Note that while FIGS. 1-5 shows hole 114 located in a particular location and perpendicular to holes 104, 106, 108, and 110, it is contemplated that hole 114 can be located in different position and angles relative to holes 104, 106, 108, and 110.

While the light source has been described internal to block 102, it is contemplated that the light source can be external to block 102. For example, the light source can be a LED positioned on an external surface of block 102. Another example of a lighting configuration includes the light source mounted to a surface of block 102 and a fiber optic element being used to control where the light shines and/or the light's intensity. For instance, the light source can be mounted on the back of block 102 and a fiber optic element can focus the light in a direction proximate hole 112. Still, in other examples, the light source may be connected to block 102 via a flexible member such that the user may direct the light's focus toward hole 112 or in other directions. For example, a flexible member containing a light source can be used by the user to direct the light's focus toward any work area.

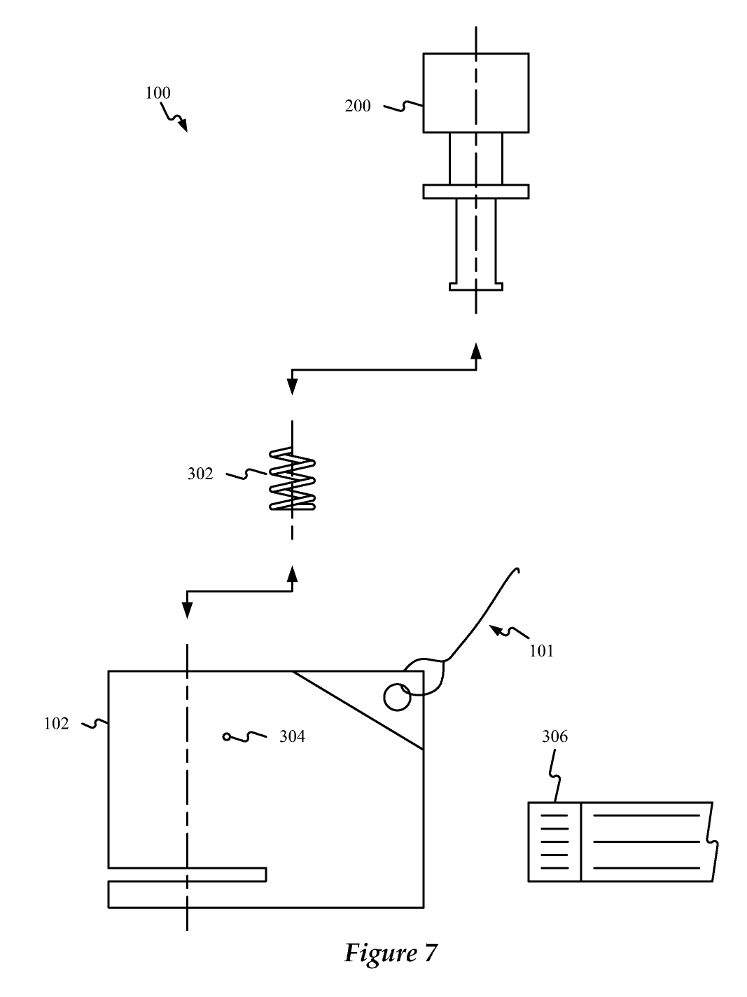

In instances where the light source is external to block 102, the light source can be connected to block 102 via connection members such a lanyard or sting. For example, when a flashlight is used as the light source, the flashlight can be connected to block 102 via a cord 101 (see FIG. 7). In such examples, when the flashlight is not inserted into block 102, block 102 and the flashlight are connected to minimize loosing either.

Turning now to FIG. 2, FIG. 2 depicts a punch 200 for use in connection with body 102. Punch 200 comprises an upper portion 202 for use in pressing punch 200 through a hunting tag that is positioned in hole 104. Punch 200 also includes an area of smaller diameter as referenced by reference number 204 to secure punch 200 into block 102 as will be discussed further with reference to FIG. 3. The portion of punch 200 used to punch through the hunting tag is facet 206.

While punch 200 can be configured to puncture the hunting tag, it is contemplated that punch 200 can be configured to mark the hunting tag with or without puncturing the hunting tag. For example, facet 206 can be fitted with an ink stamp. During operation the ink stamp can stamp the hunting tag without deforming the tag. Other embodiments of the invention can include facet 206 being configured to emboss the hunting tag. It is further contemplated that puncturing, embossing, and ink-stamping embodiments can be used singularly or in combination with each other. For instance, facet 206 can be configured to both emboss and ink stamp the hunting tag.

Turning now to FIG. 7, FIG. 7 depicts an exploded assembly of the example illuminated hunting tag punch 100. During assembly, the illuminated hole punch includes manufacturing block 102 and punch 200. These items can be formed out of plastics, metals, ceramics or any other material capable of being machined. In one example, the punch 200 comprises aluminum, aluminum alloy, or a steel alloy such as stainless steel.

During assembly, a spring 302 can be inserted into block 102. Punch 200 can be inserted into block 102. Punch 200 can be pressed such that spring 302 compresses. Once area 204 is beneath hole 304 a roll pin (not shown) or some other member can be inserted into hole 304 thereby locking punch 200 into place. The area 204 can allow punch 200 to traverse along the center line of hole 104 located in block 102. In addition, a light source 306, such as a flashlight, can be inserted into hole 114.

The manufacturing the illuminated tag punch's various components can be accomplished using standard manufacturing methods. For example, if the various components are manufactured out of a machinable such as metals or ceramics, holes 104, 106, 108, 110, 114, and 116 can be drilled. If the various components are manufactured out of plastics and polymers body 102 and punch 200 can be injection molded etc. It should also be noted that the various components and be manufactured from different materials. For instance, body 102 can be manufactured out of metal and punch 200 can be manufactured out of a polymer.

The illuminated tag punch should be sized such that it can easily fit within a hunter's pocket or pack he may be carrying. For instance, example dimensions for the illuminated tag punch can include body 102 having a length L of about 1.5 inches, a width W of about 0.75 inches, and a height H of about 1.25 inches (See FIGS. 4 and 5).

A method for punching a tag using the illuminated punch comprises activating the light source to illuminate an area proximate a tag receiver such as hole 112. Once the area proximate the tag receiver is illuminated, the tag receiver can receive the tag in the tag receiver. Once the tag is in the tag receiver the user can mark the tag buy pressing on punch 200. Activating the light source to illuminate an area proximate the tag receiver can include piping light from the light source to the area proximate the tag receiver. Marking the tag can comprise punching a hole in the tag, embossing the tag, and selecting a desired punch from a plurality of punches.

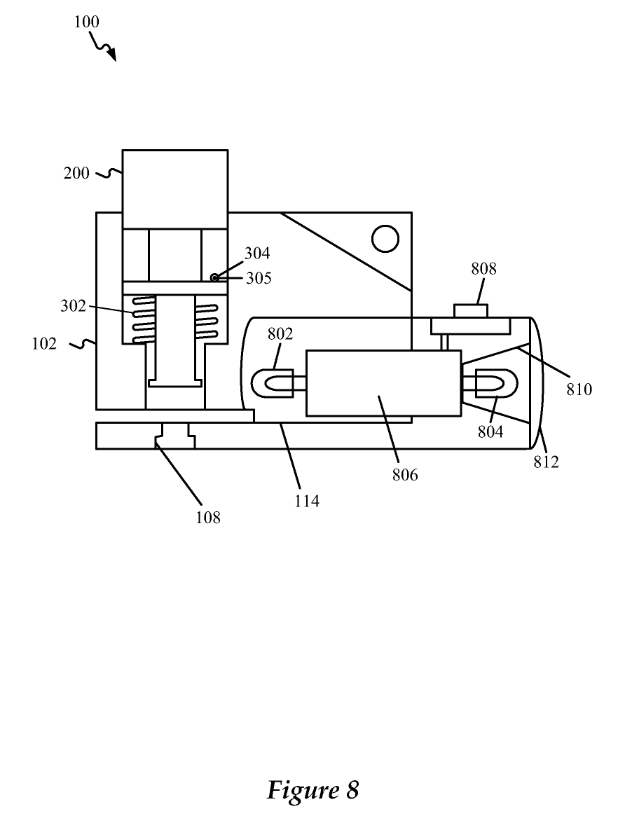

FIG. 8 depicts a cross-sectional view of another example of the illuminated hunting tag punch 100. Illuminated hunting tag punch 100 includes body 102, punch 200, spring 302, hole 304, and pin 305. In addition, illuminated hunting tag punch 100 includes a first light source 802, a second light source 804, a power source 806, and a switch 808. In some embodiments illuminated hunting tag punch 100 further includes a reflective member 810 and lens 812.

In some embodiments body 102 is a single piece of material such as formed of molded plastic. In some embodiments, body 102 is a unitary member. In other embodiments, body 102 includes multiple parts. For example, some embodiments include a removable section, such as a screw-off cap, that permits access to light sources 804 and 806 and to power source 806. This permits light sources or the power source to be replaced if necessary in some embodiments.

In this example, illuminated hunting tag punch 100 includes two light sources. The first light source 802 is arranged to shine internal to body 102, such as to illuminate a hunting tag so that it is visible through hole 108. The second light source 804 is arranged to shine external to body 102, such as to function as a flashlight. An example of a light source 802 or 804 is a bulb. Another example of a light source is a light emitting diode (LED).

Power source 806 supplies power to light sources 802 and 804. An example of power source 806 is a battery. Other embodiments include other power sources, such as an electrical generator. Yet other embodiments include a power receptacle or adapter to receive power from an external source.

Switch 808 operates to turn light sources 802 and 804 on or off. In some embodiments switch 808 is a three position switch. The first position is used to turn on the first light source 802. The second position is the off position. The third position is used to turn on the second light source 804. In another possible embodiment switch 808 is a two position switch. The first position is used to turn both light sources 802 and 804 on. The second position turns the light sources off. Electrical conductors, such as wires or metal strips are typically used to transfer power from power source 806 to switch 808 and light sources 802 and 804.

In some embodiments illuminated hunting punch tool 100 further includes a reflective member 810 and lens 812 to focus and direct light from light source 804 out from body 102.

This written description uses examples to disclose the invention, including the best mode and preferred embodiment, to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Reference may be made throughout this specification to “one embodiment,” “an embodiment,” “embodiments,” “an aspect,” or “aspects” meaning that a particular described feature, structure, or characteristic can be included in at least one embodiment of the present invention. Thus, usage of such phrases can refer to more than just one embodiment or aspect. In addition, the described features, structures, or characteristics can be combined in any suitable manner in one or more embodiments or aspects. Furthermore, reference to a single item can mean a single item or a plurality of items, just as reference to a plurality of items can mean a single item. Moreover, use of the term “and” when incorporated into a list is intended to imply that all the elements of the list, a single item of the list, or any combination of items in the list has been contemplated.

One skilled in the relevant art can recognize, however, that the invention can be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art can be made in the arrangement, operation, and details of the methods and systems of the present invention disclosed herein without departing from the scope of the claimed invention.

The above specification, examples and data provide a description of the manufacture and use of the invention. Since many embodiments of the invention can be made without departing from the spirit and scope of the invention, the invention resides in the claims hereinafter appended.

What is claimed is:

1. An illuminated punch comprising:
a punch having a facet;
a light source; and
a body configured to:
receive a tag,
receive the punch, and
receive the light source such that the light source may be activated to illuminate an area proximate the facet.

2. The illuminated punch of claim 1, wherein receiving the light source comprises the light source being internal to the body.

3. The illuminated punch of claim 1, wherein receiving the light source comprise the light source being external to the body.

4. The illuminated punch of claim 3, further comprising a fiber optic element configured to focus light emitted by the light source.

5. The illuminated punch of claim 1, wherein the light source is attachable to and detachable from the body.

6. The illuminated punch of claim 1, wherein receiving the tag comprises the body having a tapered opening for receiving the tag.

7. A method for punching a tag using an illuminated punch having a tag receiver and a light source, the method comprising:
activating the light source to illuminate an area proximate the tag receiver;
receiving the tag in the tag receiver; and
marking the tag.

8. The method of claim 7, wherein activating the light source to illuminate an area proximate the tag receiver comprises piping light from the light source to the area proximate the tag receiver.

9. The method of claim 7, wherein marking the tag comprises punching a hole in the tag.

10. The method of claim 7, wherein marking the tag comprises embossing the tag.

11. The method of claim 7, wherein marking the tag comprises selecting a desired punch from a plurality of punches.

12. An illuminated tag punch comprising:
a punch configured to puncture a tag;
a light source;
a body comprising:
a tag receiver configured to receive the tag;
a light receiver configured to receive the light source, wherein the light receiver intersects the tag receiver creating an opening such that when the light source emits light inside the body, the light escapes through the opening to illuminate an area proximate the tag receiver, and
a punch receiver configured to receive the punch; and
a cord connected to the body and the light source, wherein when the light source is not located in the light receiver the light source remains connected to the body.

13. The illuminated tag punch of claim 12, wherein the light source is a flashlight.

14. The illuminated tag punch of claim 12, wherein the punch includes an open position and a punch position, wherein when the punch is in the punch position the punch is configured to extend at least partially through the tag when the tag is inserted into the tag receiver.
